(19) United States
(12) Patent Application Publication
(10) Pub. No.: US 2025/0138240 A1
(43) Pub. Date: May 1, 2025

(54) Metastable Strained Ferroelectric Device

(71) Applicant: Lumiphase AG, Staefa (CH)

(72) Inventors: Jean Fompeyrine, Waedenswil (CH); Alan Molinari, Kilchberg (CH); Martin George Friedl, Männedorf (CH); Timo Schumann, Eschenbach (CH); Astrid Mona Josephine Norberg, Zürich (CH); Ruggero Frison, Zürich (CH)

(21) Appl. No.: 18/933,290

(22) Filed: Oct. 31, 2024

Related U.S. Application Data
(60) Provisional application No. 63/594,982, filed on Nov. 1, 2023.

(51) Int. Cl. G02B 6/036; G02B 6/12

(52) U.S. Cl. CPC G02B 6/036; G02B 6/12; G02B 2006/12061

(57) ABSTRACT

An electro-optic method and device fabricated with a metastable phase of BTO. The metastable tetragonal crystalline phase of BTO is preserved using direct wafer bonding on a thick SiO2 lower cladding layer for optical confinement in the active BTO.

### RELATED APPLICATIONS

This application claims the benefit under 35 USC 119 (e) of U.S. Provisional Application No. 63/594,982, filed on Nov. 1, 2023, which is incorporated herein by reference in its entirety.

### BACKGROUND OF THE INVENTION

Silicon photonics have become a platform for dense and low-cost photonic integrated circuits (PIC) for a wide range of applications that in many cases require fast and energy-efficient electro-optical (EO) switches.

Silicon modulators have major constraints, however. When modulating the refractive index, changes in both real and imaginary parts are impacted, leading to high insertion losses. In addition, their operating speed is limited by charge-carrier mobility in forward-biased or reverse-biased devices. The silicon based state-of-the-art modulators are often based on differently doped regions in the waveguides. Higher doping is required for higher speed operation, but higher doping increases absorption. Another option is heater-based devices. Here, a heater (often metal wire) changes the temperature via Joule heating (an electrical current), and consequently changes the temperature in a nearby waveguide. The heater, however, must be far enough that the optical mode does not see the strongly optically absorbing heater conductor. Such heater-based devices tend to be slow, have high power consumption, and can suffer from crosstalk.

Pockels materials avoid these problems. In such materials, a change of the refractive index is induced by an electric field. But no Pockels effect exists in a centrosymmetric crystal such as silicon. Thus, materials with sizeable Pockels coefficients must be integrated onto silicon photonic structures to combine the benefits of bulk Pockels modulators with the low fabrication costs of integrated silicon photonics.

Several approaches exist for integrating a material with a large effective Pockels effect in silicon based modulators. For example, the Pockels effect is present in lithium niobate (LiNbO₃, LN). And, lithium niobate has been integrated with silicon waveguides, e.g. via wafer bonding techniques. However, the size mismatch between LN wafers and silicon wafers renders the integration process difficult to scale to large substrate sizes, which results in rather high chip costs, and the magnitude of the Pockels effect in LN is limited to 20-30 pm/V.

Barium titanate (BaTiO₃, BTO), for several reasons, has emerged to enable Pockels-effect-based devices on silicon. First, BTO has one of the largest Pockels coefficients. Second, it has previously been used in thin-film EO modulators on small-size oxide substrates. Third, BTO may be grown on silicon substrates with large wafer sizes, and with excellent crystal quality, and so forth. In fact, BTO-based photonic electro-optic components on silicon wafers have been demonstrated.

BTO has different phases with different EO characteristics. The cubic phase is stable at high temperature (above Tc=120 C) and is paraelectric. It lacks a spontaneous electric polarization and does not exhibit any Pockels effects, however. Below Tc and down to room temperature, BTO has a tetragonal structure. This phase is ferroelectric, which means it has a spontaneous electric polarization that can be reversed by applying an external electric field. The Pockels effect is large, and the electro-optical properties are well defined with respect to the direction of the polarization vector. At lower temperature, BTO undergoes transition to orthorhombic and rhombohedral phases, which are also ferroelectric and show large Pockels effects.

In BTO thin films, metastable phases can exist under certain conditions. Metastable phases are not the most thermodynamically stable phases of the material for a given temperature range, but can be stabilized upon the presence of an external parameter. In thin films, the exact nature of this specific additional parameter can vary, but pressure and the resulting material strain is known to lead to the stabilization of metastable phases. This stabilization process can lead to the obtention of bulk phase outside of their typical temperature range (e.g. tetragonal BTO stabilized above Tc=120 C), or to the stabilization of structures which do not exist in their bulk form.

### SUMMARY OF THE INVENTION

Efficient EO devices using BTO need a high Pockels coefficient, low dielectric losses and low leakage currents for high performance. That said, current BTO technology is limited by a direct trade-off between the dielectric losses and the achieved Pockels coefficient.

Some metastable phases of BTO have better tradeoffs. A metastable tetragonal crystalline phase of BTO is e.g. predicted upon application of biaxial tensile strain. The bulk BTO tetragonal phase shows one long axis and two short axes of equal length, with the polarization along the long axis. The metastable BTO tetragonal phase has one short axis and two long axes of equal length. Multiple benefits can arise. Tensile strain in BTO leads to a higher bulk polarization, favoring a higher Pockels coefficient. In addition, metastable tetragonal phase would not exhibit the typical a-c crystallographic domains expected for bulk tetragonal BTO thin films. The fewer structural domain boundaries are beneficial, providing lower leakage and dielectric losses. It can also favor the formation of larger ferroelectric domains, which are again beneficial to decrease dielectric losses related to domain wall motion.

Based on this understanding, an EO device is fabricated using a metastable phase of BTO. The metastable tetragonal crystalline phase of BTO is preserved using direct wafer bonding on a thick SiO₂ lower cladding layer for optical confinement in the active BTO.

The metastable BTO phase is obtained by employing tensile strain, e.g. using stress generated by an adjacent crystalline layer with a larger lattice unit, or using stress generated by the bonding process or any other process steps. This can form metastable phases with higher Pockels effect and no in plane structural domains. The invention results in a high Pockels, low loss layer with an efficient confinement achieved in the active BTO layer showing Pockels effect.

In general, according to one aspect, the invention features an electro-optic device comprising strained Pockels material stabilized in a metastable structure bonded to a lower optical cladding layer.

In the current example, the Pockels material is BTO.

A tensile strain inducing layer, such as SrHfO₃, is preferably employed for inducing tensile strain in the Pockels material.

In general, according to one aspect, the invention features a method for fabricating an electro-optic device comprises forming a Pockels material on a tensile strain inducing layer that induces a tensile strain, transferring the Pockels material to a lower cladding layer, and forming an electrooptical device including the Pockels material.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIGS. 1A, 1B, 1C, and 1D are cross-sectional views illustrating a process for forming a metastable phase in a BTO layer in an EO device; and

FIGS. 2A, 2B, 2C, and 2D are cross-sectional views illustrating another process for forming a metastable phase in a BTO layer in an EO device.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Also, all conjunctions used are to be understood in the most inclusive sense possible. Thus, the word “or” should be understood as having the definition of a logical “or” rather than that of a logical “exclusive or” unless the context clearly necessitates otherwise. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

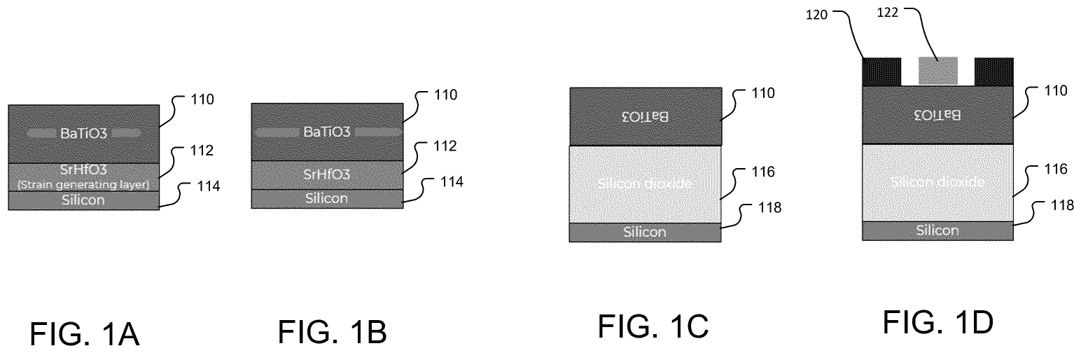

FIGS. 1A, 1B, 1C and 1D are cross-sectional views showing a process for forming an electrooptical device with a metastable BTO layer.

As shown in FIG. 1A, BTO layer 110 is formed on a SrHfO₃ layer 112, which in turn is formed on a sacrificial silicon handle wafer 114.

The SrHfO₃ is a cubic Perovskite structured crystal that functions as a tensile strain inducing layer in the BTO layer 110, which is also acting as an interface with the silicon 114. To achieve this, the SrHfO₃ is grown relaxed. The SrHfO₃ has a larger lattice than the BTO. The BTO thus tries to adapt to this larger lattice inducing a tensile strain.

As shown in FIG. 1B, the tensile strain is maintained in the BTO.

Then, as shown in FIG. 1C, in the next step of the fabrication process, the BTO is flipped and wafer bonded to a silicon dioxide lower cladding layer 116, which in turn is supported on a silicon handle wafer 118, for example.

In this transfer, the tensile strain in the BTO 110 is enhanced in order to maintain the desired metastable tetragonal crystalline phase in the BTO, taking advantage of the different coefficient of thermal expansion of silicon and BTO.

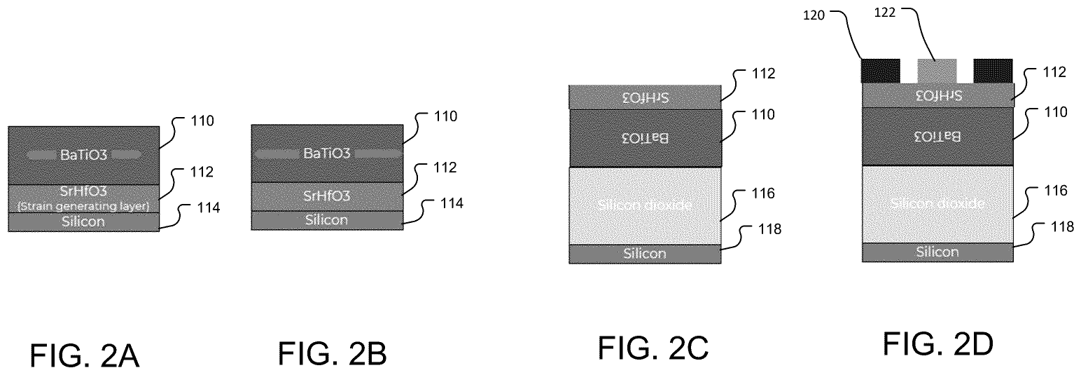

After this transfer, the sacrificial silicon 114 is removed. In addition, in different embodiments, the SrHfO₃ 112 is removed (see FIGS. 1C and 1D) or maintained (see FIG. 2A, 2B, 2C and 2D) in different embodiments.

In a typical subsequent step, upper cladding structures 120 and/or electrodes 122 are added to complete the EO device.

While this invention has been particularly shown and described with references to preferred embodiments thereof, it will be understood by those skilled in the art that various changes in form and details may be made therein without departing from the scope of the invention encompassed by the appended claims.

What is claimed is:

1. An electro-optic device comprising:
strained Pockels material stabilized in a metastable structure;
a lower optical cladding layer and possibly an upper cladding layer and/or electrodes.

2. The device as claimed in claim 1, wherein the Pockels material is BTO.

3. The device as claimed in claim 1, further comprising a tensile strain inducing layer for inducing tensile strain in the Pockels material.

4. The device as claimed in claim 3, wherein the tensile strain inducing layer includes SrHfO₃.

5. The device as claimed in claim 3, wherein the tensile strain inducing layer comprises a material with a larger lattice constant than BTO.

6. The device as claimed in claim 3, wherein the tensile strain in the Pockels material is induced by lattice mismatch, thermal coefficient of expansion differences, or a combination thereof.

7. The device as claimed in any of claim 1, wherein the metastable structure is a metastable tetragonal phase of BTO that is stabilized at a temperature above 120° C. using a tensile strain-inducing layer.

8. The electro-optic device as claimed in claim 1, further comprising an electrode arrangement configured to apply an electric field in a direction parallel to the polarization vector of the metastable phase of BTO, wherein the applied field enhances the effective electro-optic response.

9. The device as claimed in claim 1, wherein the electro-optic device further includes a waveguide layer comprising silicon or silicon nitride, optically coupled to the strained BTO material.

10. The device as claimed in claim 1, wherein the upper cladding layer comprises a low-loss dielectric material selected from the group consisting of silicon dioxide, silicon nitride, and alumina.

11. A method for fabricating an electro-optic device comprising:
forming a Pockels material on a tensile strain inducing layer that induces a tensile strain in the Pockels material;
transferring the Pockels material to a lower cladding layer; and
forming an electrooptical device including the Pockels material and possibly upper cladding layers and/or electrodes.

12. The method as claimed in claim 11, wherein the Pockels material is BTO.

13. The method as claimed in claim 11, further comprising removing the tensile strain inducing layer.

14. The method as claimed in claim 11, further comprising maintaining the tensile strain inducing layer.

15. The method as claimed in claim 11, wherein the tensile strain inducing layer includes SrHfO₃.

16. The method as claimed in claim 11, wherein the tensile strain is maintained during bonding by controlling the temperature and pressure conditions to optimize lattice alignment between the Pockels material and the cladding layer.
